(19) United States
(12) Patent Application Publication
(10) Pub. No.: US 2020/0286044 A1
(43) Pub. Date: Sep. 10, 2020

(54) MAINTENANCE STATION MANAGEMENT METHOD, SYSTEM AND DATA MANAGEMENT SERVE

(71) Applicant: LAUNCH TECH CO., LTD., Shenzhen, Guangdong (CN)

(72) Inventors: Jun LIU, Shenzhen, Guangdong (CN); Xin LIU, Shenzhen, Guangdong (CN); Rijun XIAO, Shenzhen, Guangdong (CN)

(21) Appl. No.: 16/060,867

(22) PCT Filed: May 30, 2018
(86) PCT No.: PCT/CN2018/089032

§ 371 Date: Jun. 8, 2018

(51) Int. Cl. G06Q 10/00; G06F 16/23; G06F 16/27; G06Q 10/10; G06Q 20/08; G06Q 10/06

(52) U.S. Cl. CPC G06Q 10/20; G06F 16/2379; G06Q 10/06375; G06Q 10/10; G06Q 20/085; G06F 16/27

(57) ABSTRACT

The present application discloses a maintenance station management method, maintenance station management system and a data management server, this method comprises: receiving, via a data management server, a transaction request of using a maintenance station from a first user and calling a usage smart contract of the maintenance station to grant a permission of usage of the maintenance station to the first user according to the transaction request; initiating a transaction payment request, calling the usage smart contract to finish a payment transaction according to a transaction payment confirmation instruction of the first user, and performing a sharing according to a transaction sharing rule of the usage smart contract via the data management server, when the first user finishes using the maintenance station; and receiving, via a block chain node device, transaction information submitted by the data management server and registering the transaction information into a block chain.

### TECHNICAL FIELD

The present application pertains to the technical field of equipment maintenance, and particularly to a maintenance station management method, a maintenance station management system and a data management server.

### BACKGROUND

With the continuous development and progress of the society, the number of vehicles is increasing with time went on, which enables service requirements of vehicle repair and maintenance to increase day after day.

Currently, vehicle repair and maintenance usually needs to be performed in a vehicle maintenance plant, the vehicle maintenance plant operates according to fixed working time and provides vehicle maintenance service to the outside so as to gain profit. However, an establishment of the vehicle maintenance plant is finished by renting or purchasing a site, purchasing a large number of maintenance equipment, and hiring a technician team and an operation and maintenance team via a boss of the maintenance plant. In this mode, the boss of the maintenance plant boss requires a lot of funds to make site investment, equipment investment and management investment, there is a high requirement for an access threshold of an investment party. What's more, the size of the site is fixed, and a configuration of the maintenance equipment may not always match with the site completely, which may result in a condition that a part of the maintenance site is idle, and a utilization rate of the site is low. In addition, a sharing manner of maintenance income generated by a conventional vehicle maintenance plant requires a manual participation, reliability and convenience of this sharing manner are low. In particular, when there are many investment parties, the transaction process under the present mode, the transparency, the reliability and the convenience of income sharing are much lower.

### Technical Problem

In view of this, embodiments of the present application provide a maintenance station management method, a maintenance station management system and a data management server, which aims at solving a problem that credibility, transparency, and convenience of sharing manner of maintenance income in related art is much lower.

### Technical Solution

A first aspect of embodiments of the present application provide a maintenance station management method comprising: receiving, via a data management server, a transaction request of using a maintenance station from a first user and calling a usage smart contract of the maintenance station to grant a permission of usage of the maintenance station to the first user according to the transaction request; initiating a transaction payment request, calling the usage smart contract to finish a payment transaction according to a transaction payment confirmation instruction and performing a sharing according to a transaction sharing rule of the usage smart contract via the data management server, when the first user finishes using the maintenance station; and receiving, via a block chain node device, transaction information submitted by the data management server and registering the transaction information into a block chain.

A second aspect of the embodiments of the present application provides a maintenance station management method which is applied in a data management server and comprises:

receiving a transaction request of using a maintenance station from a first user; calling a usage smart contract of the maintenance station to grant a permission of usage of the maintenance station to the first user according to the transaction request; initiating a transaction payment request when the first user finishes using the maintenance station; calling the usage smart contract to finish a payment transaction according to a transaction payment confirmation instruction of the first user, and performing a sharing according to a transaction sharing rule of the usage smart contract; and sending transaction information to a block chain node device, so that the block chain node device registers the transaction information into a block chain.

Selectively, before receiving the transaction request of using the maintenance station from the first user, the method further comprises:

receiving a usage agreement of the maintenance station; and sending the usage agreement to the block chain node device, so that the block chain node device generates the usage smart contract of the maintenance station according to the usage agreement.

Selectively, before receiving the usage agreement of the maintenance station submitted, the method further comprises:

receiving maintenance station information and investment cost information of the maintenance station submitted by the second user; establishing a correlation between the investment cost information and the maintenance station information, generating digital asset information of the maintenance station; and sending the digital asset information of the maintenance station to the block chain node device, so that the block chain node device registers the digital asset information of the maintenance station into a block chain.

Selectively, after sending the transaction information to the block chain node device, the method further comprises:

calculating return on investment according to the transaction information and the investment cost information of the maintenance station; and sending the return on investment to the block chain node device, so that the block chain node device establish the correlation between the return on investment and the digital asset information of the maintenance station, and registers the correlation into the block chain.

Selectively, after sending the return on investment to the block chain node device, the method further comprises:

receiving a financing agreement submitted by the second user; sending the financing agreement to the block chain node device, so that the block chain node device generates a financing smart contract of the maintenance station according to the financing agreement; receiving financing amount information submitted by a third user; and calculating return on investment of the third user according to the financing amount information.

A third aspect of the embodiments of the present application provides a maintenance station management system comprising:

a data management server configured to: receive a transaction request of using a maintenance station from a first user and call a usage smart contract of the maintenance station to grant a permission of usage of the maintenance station to the first user according to the transaction request; initiate a transaction payment request and call the usage smart contract to finish a payment transaction according to a transaction payment confirmation instruction of the first user and perform a sharing according to a transaction sharing rule of the usage smart contract, when the first user finishes using the maintenance station; and a block chain node device configured to receive transaction information submitted by the data management server and register the transaction information into a block chain.

A fourth aspect of the embodiments of the present application provides a data management server comprising a memory, a processor and maintenance station management program stored in the memory and executable by the processor, when executing the maintenance station management program, the processor is configured to: receive a transaction request of using a maintenance station from a first user; call a usage smart contract of the maintenance station to grant a permission of usage of the maintenance station to the first user according to the transaction request; initiate a transaction payment request when the first user finishes using the maintenance station; call the usage smart contract to finish a payment transaction according to a transaction payment confirmation instruction of the first user and perform a sharing according to a transaction sharing rule of the usage smart contract; and send transaction information to a block chain node device, so that the block chain node device registers the transaction information into a block chain.

Selectively, the processor is further configured to: receive a usage agreement of the maintenance station before receiving the transaction request of using the maintenance station from the first user; and send the usage agreement to the block chain node device, so that the block chain node device generates the usage smart contract of the maintenance station according to the usage agreement.

Selectively, the processor is further configured to: receive maintenance station information and investment cost information of the maintenance station submitted by a second user before receiving the usage agreement of the maintenance station submitted; establish a correlation between the investment cost information and the maintenance station information and generate digital asset information of the maintenance station; and send the digital asset information of the maintenance station to the block chain node device, so that the block chain node device registers the digital asset information of the maintenance station into a block chain.

Selectively, the processor is further configured to: calculate return on investment according to the transaction information and the investment cost information of the maintenance station after sending the transaction information to the block chain node device; and send the return on investment to the block chain node device, such that the block chain node device establishes correlation between the return on investment and the digital asset information of the maintenance station, and registers the correlation into the block chain.

Selectively, the processor is further configured to: receive a financing agreement submitted by the second user after sending the return on investment to the block chain node device; send the financing agreement to the block chain node device, so that the block chain node device generates a financing smart contract of the maintenance station according to the financing agreement; receive financing amount information submitted by a third user; and calculate the return on investment of the third user according to the financing amount information.

### Advantageous Effects

In the embodiments of the present application, the transaction request of using the maintenance station from the first user is received by the data management server, the usage smart contract of the maintenance station is called to grant the permission of usage of the maintenance station to the first user according to the transaction request; when the first user finishes using the maintenance station, the transaction payment request is submitted, the usage smart contract is called by the data management server to finish payment transaction according to the transaction payment confirmation instruction of the first user, and the sharing is performed according to the transaction sharing rule of the usage smart contract; and the transaction information submitted by the data management server is received by the block chain node device and is registered into the block chain. We can see that, if the maintenance station is enabled to provide maintenance service to the external in the form of shared maintenance station through the maintenance station management system, an idle rate of maintenance site can be reduced, and thus an utilization rate of the maintenance site can be improved; moreover, the transaction process of the maintenance station needs to rely on the usage smart contract on the block chain, the income sharing is calculated automatically using the transaction sharing rule of the usage smart contract, such that the transparency, the reliability and the convenience of the transaction process of the maintenance station and the computational process of the income sharing are improved.

### BRIEF DESCRIPTION OF THE DRAWINGS

In order to describe the technical solution of the present application more clearly, the accompanying figures that need to be used in the descriptions of the embodiments or the related art are introduced briefly below:

FIG. 1 illustrates a schematic block diagram of system architecture of a maintenance station management system provided by an embodiment of the present application;

FIG. 2 illustrates a schematic flow block diagram of a maintenance station management method provided by an embodiment of the present application;

FIG. 3 illustrates a schematic flow diagram of a maintenance station management method which is applied in a data management server and is provided by an embodiment of the present application;

FIG. 4 illustrates an another schematic flow diagram of the maintenance station management method which is applied in the data management server and is provided by the embodiment of the present application;

FIG. 5 illustrates an another schematic flow diagram of the maintenance station management method which is applied in the data management server and is provided by the embodiment of the present application;

FIG. 6 illustrates a schematic block diagram of a structure of a maintenance station management system provided by an embodiment of the present application; and

FIG. 7 illustrates a schematic block diagram of a structure of a data management server provided by an embodiment of the present application.

### PREFERRED EMBODIMENTS OF THE PRESENT APPLICATION

In the following descriptions, in order to illustrate but not to limit the present application, specific details such as a specific system structure, techniques or the like are proposed, thereby facilitating a thorough understanding of embodiments of the present application.

In order to illustrate the technical solution in the present application, the present application is described with reference to particular embodiments below:

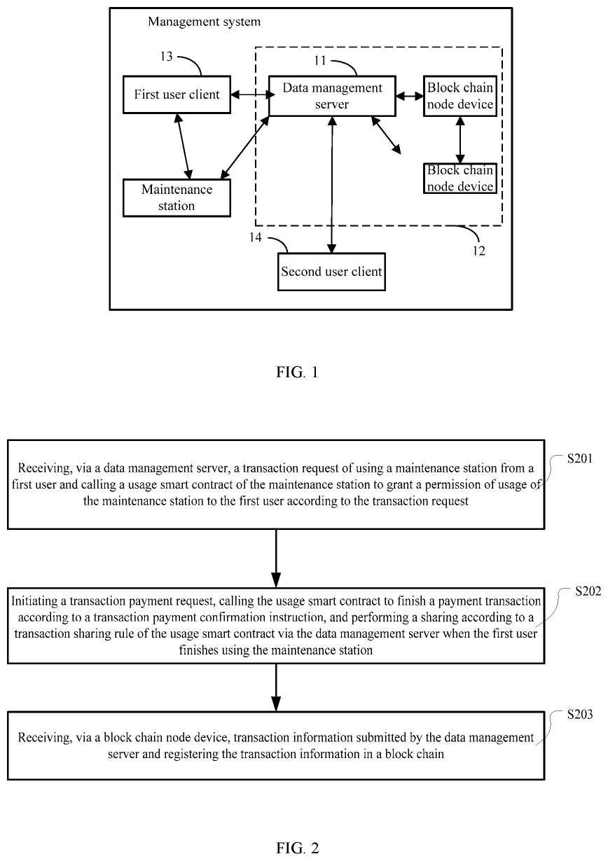

Firstly, an embodiment of the present application with reference to FIG. 1 provides a schematic block diagram of system architecture of a maintenance station management system, the system architecture involved in the technical solution of the embodiment of the present application, and some possible application scenarios are introduced by examples.

The maintenance station management system shown in FIG. 1 comprises a data management server 11, a block chain containing a plurality of block chain node devices serving as block chain nodes, a first user client 13 and a second user client 14. The data management server 11 are connected in communication with the block chain 12, the first user client 13 and the second user client 14 are connected with the data management server 11 in communication respectively.

It needs to be explained that, the data management server 11 can either be a single server that communicates with a block chain node device, thereby accessing the block chain 12, or be registered in the block chain 12 and become a node device of the block chain. The data management server 11 is integrated with data management platform program used for managing the maintenance station.

The aforesaid first user client 13 can be a maintenance transaction client, a user can finish a transaction operation such as reservation, usage and payment of the maintenance station and so on related to the maintenance station through the maintenance transaction client. The second user client can be client of an investor, that is, the investor can get to know an operation condition of the maintenance station and relevant information of other maintenance stations, or manage the maintenance station. The aforesaid investor is referred to as the investor of the maintenance station, which can either be an owner of the maintenance station or be a renter or a purchaser of the maintenance station. The aforesaid maintenance station is referred to as a site for performing maintenance.

The investor rents or purchases the maintenance station, brings a plurality of cooperation partners including an owner of the maintenance equipment, an operation and maintenance team and an operator of the data management platform together to constitute the maintenance station capable of providing maintenance services for users who need service of maintenance. The maintenance service provided by the maintenance station can be automobile maintenance service, and is not restricted to automobile maintenance service, the maintenance service can be, for example, an electrical equipment maintenance service.

For example, the maintenance station can be, in particular, the automobile maintenance station, the first user client 13 can be, in particular, a client of a maintenance technician. After the maintenance station is rented or repaired, the investor of the maintenance station searches and brings the owner of the automobile maintenance equipment, the operation and maintenance team of the maintenance station together to constitute the maintenance station capable of providing automobile maintenance service, then, the plurality of cooperation partners come to a usage agreement of the maintenance station including a maintenance station reservation rule, maintenance service item information, a charging rule and an income sharing rule by negotiation, the usage agreement is submitted by the investor of the maintenance station to the data management server through the second user client 14, and then is sent to the block chain node device by the data management server, such that the block chain node device registers the usage agreement in the form of usage smart contract into the block chain. A vehicle owner who wants to have automobile maintenance service needs to issue an automobile maintenance order on the first user client, the automobile maintenance order can include but is not limited to automobile maintenance item information and maintenance time information. After the maintenance technician receives the automobile maintenance order issued by the vehicle owner through the first user client, a proper maintenance station is reserved for use; wherein, a maintenance technician is required to determine relevant information including maintenance time, related information of the vehicle (e.g., vehicle license plate information) to be maintained, maintenance service needed to be used during reservation, a reservation use request of the maintenance station from the maintenance technician will be sent to the data management server to be stored.

After the reservation is successful, the maintenance technician acquires the vehicle of the vehicle owner to be maintained, and uses the maintenance station to perform maintenance for the vehicle to be maintained, the maintenance technician submits a transaction request to the data management server through the first user client, the data management server detects the permission of usage of the maintenance technician (i.e., the first user) according to the transaction request; for example, the data management server detects whether the first user has been registered or not, and whether a deposit is paid or not. If the permission of usage is met, the usage smart contract is called, and the corresponding permission of usage of the maintenance station is open to the maintenance technician. When the automobile maintenance technician finishes using the maintenance station, an end use instruction is sent to the data management server through the first user client, the data management server sends a transaction payment request to the first user client after the use cost that needs to be paid by the maintenance technician is determined according to service condition of the maintenance technician and a charging rule of the usage smart contract; the maintenance technician pays the corresponding use fee through the first user client. After receiving the information indicating that the transaction is finished, the data management server calls a transaction sharing rule of the usage smart contract to share the maintenance income to all cooperation partners (the maintenance station investment party, the owner of the maintenance equipment, the maintenance station operation and maintenance team, and management party of the data management platform), and then sends the transaction information such as maintenance income information, income sharing information, and use record information of the maintenance technicians and the like to the block chain to be recorded; the block chain node device receives the transaction information submitted by the data management server and registers the transaction information into the block chain.

The technical solution provided by the embodiment of the application based on the architecture of the maintenance station management system is described fully and in detail below.

Please refer to FIG. 2, FIG. 2 illustrates a schematic flow block diagram of the maintenance station management method provided by the embodiment of the present application, the method can comprise following steps:

Step 201, receiving, via a data management server, a transaction request of using a maintenance station from a first user, calling a usage smart contract of the maintenance station to grant a permission of usage of the maintenance station to the first user according to the transaction request.

It should be noted that, the usage smart contract is generated based on a usage agreement of the maintenance station. The usage agreement of the maintenance station can include a reservation rule, a usage agreement, maintenance service item information, a charging rule and an income sharing rule of the maintenance station. The plurality of cooperation partners including the maintenance station investment party, the owner of the maintenance equipment, and the maintenance station operation and maintenance team, the management party of the data management platform come to the usage agreement of the maintenance station aiming at the service rule of the maintenance station and relevant income sharing rule, and the usage agreement of the maintenance station is submitted to the data management server by the maintenance station investment party, and then is sent to the block chain node device by the data management server, such that the block chain node device generates the usage smart contract based on the usage agreement and registers the usage smart contract in the block chain so as to be broadcasted in a whole network. The usage smart contract can make a transaction which is generated by performing usage smart contract through doing corresponding action (e.g., starting to provide the maintenance station for the user to use) under the condition (e.g., the condition that the smart contract is triggered to be executed can be receiving a code scanning operation of the user) that the usage smart contract is triggered to be executed according to a plurality of pre-determined rules.

Wherein, the aforesaid maintenance station reservation rule can comprise relevant rules when the user reserves the maintenance station; the charging rule comprises cost rules of various maintenance services of the maintenance station; the income sharing rule comprises maintenance income sharing proportion of the various cooperation partners; the maintenance service item information is referred to as a maintenance service type which can be provided by the maintenance station.

The first user can be a user of the maintenance station, and can be particularly represented as the maintenance technician; of course, if the vehicle owner has the corresponding maintenance skill, he/she can also be represented as the vehicle owner of the vehicle to be maintained.

The transaction request can include but is not limited to user information of the first user, and related information of the transaction request and the like. The transaction request can be, in particular, triggered by the first user by scanning corresponding two-dimensional code of maintenance station through the first user client; for example, after the first user arrives at the maintenance station in the reservation time period, he/she uses the two-dimensional codes provided by using the first user terminal side to scan the client scanning maintenance station to sign in or utilize the maintenance resources in the maintenance station. Certainly, the transaction request can also be triggered by other approaches, for example, trigged by iris, sound, fingerprint and other biological characteristic information of the first user, the transaction request can also be triggered by license plate information of the vehicle to be maintained.

After receiving the transaction request, the data management server determines whether the current user meets the usage agreement in the usage smart contract according to relevant information carried by the transaction request; for example, whether current time is within the reservation time period of the user, whether the user is authenticated by the technician and whether the user pays a deposit is judged. If the usage agreement is met, the corresponding permission of usage of the maintenance station is open to the current user.

The permission of usage of the maintenance station can be a passing authority of gate machine of the maintenance station, a service authority of maintenance equipment in the maintenance station, and the like, particularly, relevant permission can be open to the user by sending a passing password or use password of related permission to the first user client; or as an alternative, the relevant permission can be open to the user by sending an instruction to relevant equipment via the data management server. After the permission of usage of the maintenance station is open to the first user, the first user can use the maintenance resources of the maintenance station to perform maintenance operation for the vehicle to be maintained. For example, after an access permission of the maintenance station is open to the first user, the data management server will send a passing instruction to the gate or an entrance/exit of the gate of the maintenance station, the first user can drive the vehicle to be maintained to pass through the gate or the entrance/exit of the gate, and then use the service authority of the maintenance resources to perform vehicle maintenance.

Step 202, submitting, via the data management server, a transaction payment request when the first user finishes using the maintenance station, and calling the usage smart contract to finish the payment transaction according to the transaction payment confirmation instruction of the first user, and performing a sharing according to the transaction sharing rule of the usage smart contract.

Particularly, when the first user finishing using the maintenance station, the data management server calculates charge amount of the transaction according to the charging rule in the usage smart contract and use condition (e.g., service time, the type of the used equipment) of the first user after an end use instruction sent by the first user client is received, and sends a payment request containing the charge amount to the first user, the first user receives the transaction payment request through the first user client and performs corresponding payment operation.

After the first user finishes the payment, the data management server calls the usage smart contract on the block chain to finish the payment transaction, and share the maintenance income according to the transaction sharing rule in the usage smart contract.

The transaction sharing rule includes sharing proportion information of the income generated by the transactions previously achieved by various cooperation partners (i.e., the maintenance station investment party, the owner of the maintenance equipment, the maintenance station operation and maintenance team, the management party of the data management platform) and written into the usage agreement.

For example, the share proportion of the maintenance station investment is 50%, the share proportion of the maintenance equipment is 40%, the share proportion of the operation and maintenance team of the maintenance station is 5%, and the share proportion of the management party of the data management platform is 5%. When the maintenance income is 100 RMB, according to the transaction dividing rule, the shared income share of the investment party of the maintenance station is calculated to be 50 RMB, the shard income of the owner of the maintenance equipment is calculated to be 40 RMB, the shard income of the maintenance station operation and maintenance team is calculated to be 5 RMB, and the shared income of the management party of the data management platform is calculated to be 5 RMB. Since the technician has come to agreement with the vehicle owner regarding the maintenance service cost before the maintenance station is used, the income in the present application is the rental fee required to be paid for renting the maintenance station, thus, with regard to income sharing, the technicians are unconsidered.

It can be understood that, the calculation time of the income can be periodic and can also be real-time. That is, income sharing of the various cooperation partners are automatically calculated for every preset time period, for example, the usage smart contract is called to calculate the income sharing of the various cooperation partners from the block chain based on the transaction information stored on the block chain node device for every month; or as an alternative, the income of the cooperation partners can be calculated in real time, once the transaction is made, the calculation is performed one time. Certainly, the income sharing can also be calculated according to calculation requirement of the user.

Step 203, receiving, via the block chain node device, the transaction information submitted by the data management server and registering the transaction information into a block chain.

It should be noted that, said transaction information is referred to as the transaction information between the first user and the maintenance station, and can include all information generated in the transaction process including the maintenance cost paid by the first user, the service time period of the first user, the service time duration, and the calculated income sharing.

The data management server sorts and packages the related information generated in the transaction process and uploads the related information to the block chain node device, the block chain node device stores the received transaction information and broadcasts the transaction information in a whole network.

In this embodiment, the maintenance station is enabled to provide maintenance service to the external in the form of a shared maintenance station, an idle rate of maintenance site can be reduced, and an utilization rate of the maintenance site can be improved; moreover, the transaction process of the maintenance station relies on the usage smart contract on the block chain, and the income sharing is calculated automatically using the transaction sharing rule of the usage smart contract, such that the transparency, the reliability and the convenience of the transaction process of the maintenance station and the computational process of the income sharing are improved.

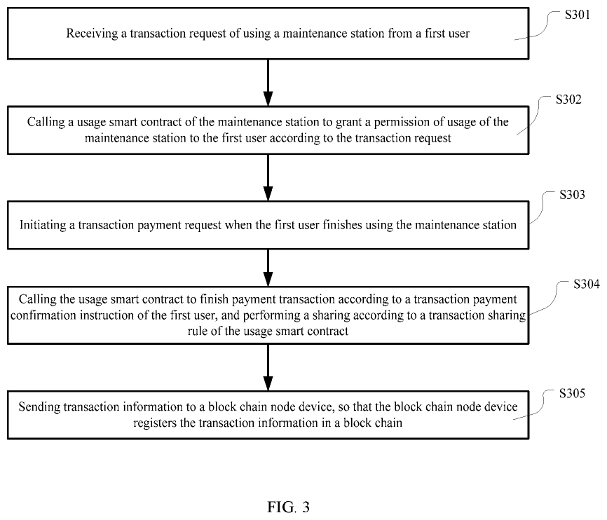

Please refer to FIG. 3, FIG. 3 illustrates a schematic flow diagram of a maintenance station management method according to an embodiment of the present application, the maintenance station management method is particularly applied to a data management server and can comprise following steps:

Step 301, receiving a transaction request of using a maintenance station from a first user. Step 302, calling a usage smart contract of the maintenance station to grant a permission of usage of the maintenance station to the first user according to the transaction request.

Step 303, initiating a transaction payment request when the first user finishes using the maintenance station.

Step 304, calling the usage smart contract to finish payment transaction according to a transaction payment confirmation instruction of the first user, and performing sharing according to the transaction sharing rule of the usage smart contract.

Step 305, sending transaction information to a block chain node device, such that the block chain node device registers the transaction information into the block chain.

It should be noted that, regarding the part of the embodiment that is the same or similar to the embodiments mentioned above, reference can be made to relevant descriptions of the embodiments mentioned above, and it is not repeatedly described herein.

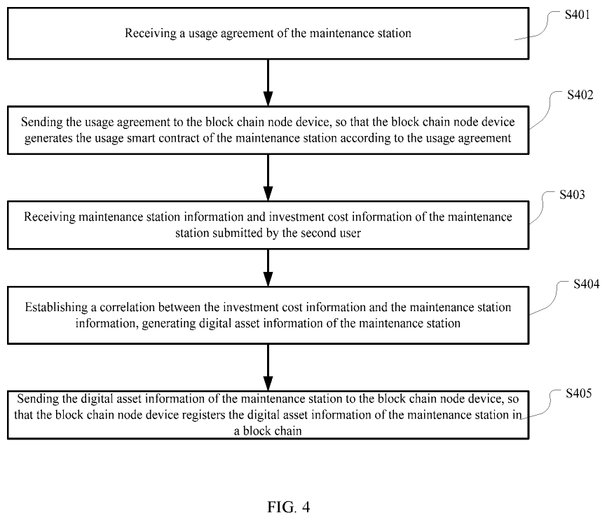

In some embodiments of the present application, please refer to FIG. 4, before step 301 described above, that is, before the step of receiving the transaction request of using the maintenance station from the first user, the method can further comprise:

Step 401, receiving a usage agreement of a maintenance station.

Step 402, sending the usage agreement to the block chain node device, so that the block chain node device generates the usage smart contract of the maintenance station according to the usage agreement.

It should be noted that the aforesaid usage agreement is a maintenance station usage agreement achieved by a plurality of cooperation partners, which can be particularly confirmed by the various cooperation partners including the maintenance station investment party, the owner of the maintenance equipment, the operation and maintenance team of the maintenance station, the management party of the data management platform according to a template agreement provided by the data management server, and then is submitted to the data management server by any one of the cooperation partners, and is submitted to the block chain node device by the data management; the aforesaid usage agreement can also be a usage agreement prepared by the various cooperation partners including the maintenance station investment party, the owner of the maintenance equipment, the operation and maintenance team of the maintenance station, the management party of the data management platform after a cooperation intension is achieved by negotiation.

The usage agreement may include but is not limited to the usage agreement of the maintenance station such as how much money should be paid when different types of equipment are used for different time, the support for payment, the income sharing rule of the maintenance station and so on.

After receiving the usage agreement, the data management server sends the usage agreement to the corresponding block chain node device, the block chain node device generates the usage smart contract according to the aforesaid usage agreement, stores the usage smart contract and broadcasts the usage agreement in the whole network.

Step 403, receiving maintenance station information and investment cost information of the maintenance station submitted by a second user.

Step 404, establishing a correlation between the investment cost information and the maintenance station information, and generating maintenance station digital asset information.

Step 405, sending the maintenance station digital asset information to the block chain node device, so that the block chain node device registers the maintenance station digital asset information into the block chain.

It can be understood that, an execution order of steps 401-402 and an execution order of steps 403-405 can be arbitrary, it is not limited herein.

After the usage agreement achieved by the various cooperation partners is registered in the block chain in the form of smart contract, and the maintenance station is registered in the block chain in the form of digital asset, the data management server can receive the transaction request of using the maintenance station from the first user, and then perform the subsequent steps 302-305; regarding the detail of steps 302-305, reference can be made to the embodiment shown in FIG. 3, and it is not repeatedly described herein.

It needs to be explained that, the second user can be the maintenance station investment party and can also be other users. The maintenance station information can include but is not limited to location information, size information, quantity information and purchase price information of the maintenance site. The investment cost information can be the cost consumed by renting or purchasing the maintenance station.

The data management server stores the investment cost information and the maintenance station information in association, thereby generating digital asset information. The digital asset information is presented in the form of electronic data, and can reflect the ownership and the right of use of tangible asset. Then, the digital asset information is sent to the node device of the block chain network, a unique identification can be generated along with the digital asset through the block chain technology, and then deployed on the block chain node device, such that an authentication of the digital asset based on the block chain can be achieved, moreover, because that the block chain has the characteristics of tracing and tamper resistance, the digital asset information is uploaded to the block chain to be authenticated, so that the reliability is improved.

In this embodiment, the received usage agreement of the maintenance station is pre-received and is registered in the block chain in the form of smart contract, so that subsequent calling is facilitated; moreover, the relevant information and the investment cost information of the maintenance station are associated and stored in the block chain in the form of digital asset, by utilizing the characteristics of the block chain, the relevant information of the maintenance station, the reliability and the transparency of the transaction process of the subsequent maintenance station and the computational process of the income sharing can be further improved.

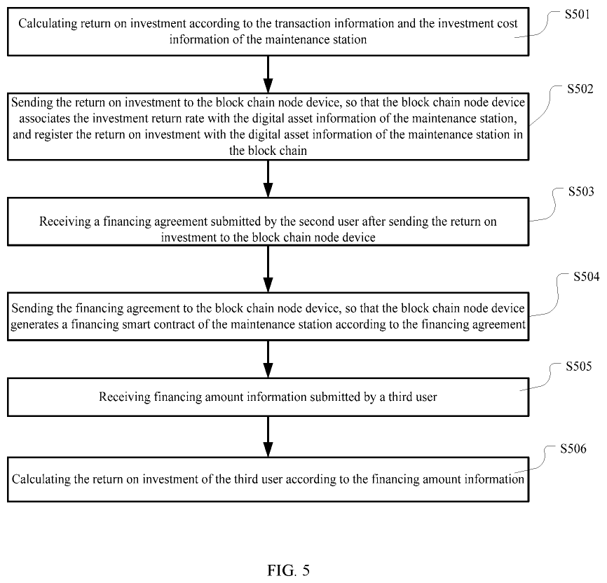

please refer to FIG. 5, FIG. 5 is a schematic flow diagram of a maintenance station management method provided by an embodiment of the present application, based on the embodiments described above, that is, the further optimized embodiment based on any of the embodiments shown in FIGS. 2-4, the maintenance station management method further comprise:

after step 305 described above, that is, after the step of sending the transaction information to the block chain node device,

step 501, calculating return on investment according to the transaction information and the investment cost information of the maintenance station.

Step 502, sending the return on investment to the block chain node device, so that the block chain node device establishes a correlation between the return on investment and the maintenance station digital asset information and registers the correlation into the block chain.

Particularly, after the income of the various investment parties are calculated according to the transaction information, the return on investments of the maintenance station investment party are calculated according to the investment cost and the income of the maintenance station investment party, and the return on investment of the maintenance station investment party is calculated. Then, the calculated return on investment is uploaded to the block chain, and the return on investment is associated with the digital asset information of the shared maintenance station. In this way, other investors can check relevant information of the shared maintenance station through the block chain, and check the return on investment, either.

It can be understood that the return on investment can be calculated according to the real-time transaction information and the investment cost information acquired from nodes of the block chain network. The return on investment can also be calculated according to the transaction information and the investment cost information acquired from the block chain network node device in a certain period of time.

Step 503, receiving a financing agreement submitted by the second user after the return on investment is sent to the block chain node device.

Step 504, sending the financing agreement to the block chain node device, so that the block chain node device generates a financing smart contract of the maintenance station according to the financing agreement.

It needs to be noted that, when the second user (i.e., the maintenance station investment party) needs to expand the business of the maintenance station, more funds are required to be invested, at this moment, the financing agreement can be established by the second user, the aforesaid financing agreement can be an agreement established by the second user and other users (maintenance station investment party, the owner of the maintenance equipment, the operation and maintenance team of the maintenance station, and the management party of the data management platform) related to the maintenance station.

The aforesaid financing agreement may include but is not limited to a financing rule and a financing income sharing rule; the financing agreement is sent to the block chain node device, when receiving the financing agreement, the block chain node device can generate the financing smart contract by applying technical means including data encryption and time stamp, using the block chain technology and according to the financing agreement, and associate the financing smart contract of the maintenance station with the return on investment which is updated in real-time, such that a financer can take the financing smart contract obtained from any node in the block chain network and the previous return on investment information as reference.

Step 505, receiving financing amount information from a third user.

Step 506, calculating return on investment of the third user according to the financing amount information.

The aforesaid third user is referred to as a financer who can acquire relevant information (e.g., the digital asset information, the transaction information and the return on investment of the maintenance station and the like) of the maintenance station through the block chain network. Relying on the information, the third user can determine whether a financing is necessary, and how much money should be financed according to the information on the block chain.

After receiving the financing amount information, the data management server can calculate the return on investment that corresponds to the financing amount information according to the ratio of the previous investment cost information to the return on investment and the usage smart contract called from the block chain network node device. The aforesaid return on investment is sent to the third user client, or is sent in the form of information to a mobile terminal pre-registered by the third user, thereby providing reference for the third user.

In this embodiment, the calculated return on investment of the maintenance station is uploaded to the block chain, and is associated with the maintenance station digital asset information, so that the reliability and the transparency of related information of the maintenance station can be ensured. Then, a financing enthusiasm of the financing person is encouraged by using the transparent and credible data.

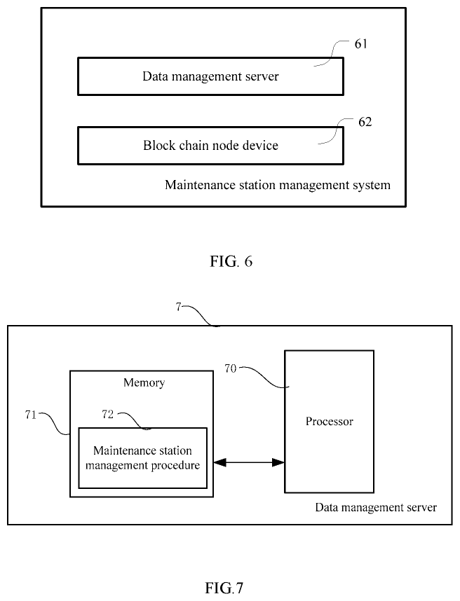

Please refer to FIG. 6, FIG. 6 illustrates a schematic structural block diagram of a maintenance station management system provided by an embodiment of the present application, this system can comprise:

a data management server 61 configured to: receive a transaction request of using a maintenance station from a first user, call a usage smart contract of the maintenance station to grant a permission of usage of the maintenance station to the first user according to the transaction request; initiate a transaction payment request when the first user finishes using the maintenance station, call the usage smart contract to finish payment transaction according to a transaction payment confirmation instruction of the first user, and perform a sharing according to a transaction sharing rule in the usage smart contract;

a block chain node device 62 configured to receive the transaction information submitted by the data management server and register the transaction information into the block chain.

It should be noted that, regarding the part of this embodiment that is similar or same to the various embodiments described above, reference can be made from each other, and it is not repeatedly described herein.

In this embodiment, the maintenance station is enabled to provide maintenance service to the external in the form of a shared maintenance station through the maintenance station management system, such that an idle rate of maintenance site can be reduced, and thus a utilization rate of the maintenance site can be improved; moreover, the transaction process of the maintenance station needs to rely on the usage smart contract on the block chain, the income sharing is calculated automatically using the transaction sharing rule of the usage smart contract, such that the transparency, the reliability and the convenience of the transaction process of the maintenance station and the computational process of the income sharing are improved.

The data management server provided by the embodiment of the present application is described below. FIG. 7 is a schematic view of the data management server according to an embodiment of the present application. As shown in FIG. 7, the data management server 7 of the embodiment comprises a processor 70, a memory 71, and a management program 72 stored in the memory 71 and can be executable by the processor 70, when executing the management program 72 of the maintenance station, the processor 70 is configured to: receive a transaction request of using a maintenance station from the first user; call the usage smart contract of the maintenance station to grant a permission of usage of the maintenance station to the first user according to the transaction request; initiating a transaction payment request when the first user finishes using the maintenance station; call the usage smart contract to finish payment transaction according to transaction payment confirmation instruction of the first user, and perform a sharing according to a transaction sharing rule of the usage smart contract; and send the transaction information to the block chain node device, so that the block chain node device registers the transaction information into the block chain.

In some embodiments, the processor may also be configured to: receive a usage agreement of a maintenance station; send the usage agreement to the block chain node device, such that the block chain node device generates the usage smart contract of the maintenance station according to the usage agreement.

In some embodiments, the processor may also be configured to: receive maintenance station information and investment cost information of the maintenance station submitted by a second user; establish a correlation between the investment cost information and the maintenance station information, generate maintenance station digital asset information; send the maintenance station digital asset information to the block chain node device, such that the block chain node device registers the maintenance station digital asset information into the block chain.

In some embodiments, the processor can also be configured to calculate return on investment according to the transaction information and the investment cost information of the maintenance station; send the return on investment to the block chain node device, such that the block chain node device establishes a correlation between the return on investment and the maintenance station digital asset information and registers the correlation into the block chain.

In some embodiments, the processor may also be configured to: receive a financing agreement submitted by a second user; send the financing agreement to the block chain node device, such that the block chain node device generates a financing smart contract of the maintenance station according to the financing agreement; receive financing amount information of a third user; and calculate a financing return rate of the third user according to the financing amount information.

It can be understood that, the aforesaid data management server 7 can include but is not limited to the processor 70, the memory 71. FIG. 7 is merely an example of the data management server 7, and is not constituted as the limitation to the data management server 7, more or less components shown in FIG. 7 can be included, or some components or different components can be combined; for example, the aforesaid data management server 7 can also include an input and output device, a network access device, a bus, etc.

The memory 71 can be an internal storage unit of the data management server 7, such as a hard disk or a memory of the data management server 7. The memory 71 can also be an external storage device of the data management server 7, such as a plug-in hard disk, a SMC (Smart Media Card), a SD (Secure Digital) card, a FC (Flash Card) equipped on the data management server 10. Further, the memory 71 may include both the internal storage unit and the external storage device of the data management server 7, either. The memory 71 is configured to store the computer programs, and other procedures and data needed by the data management server 7. The memory 71 can also be configured to storing data that has been output or being ready to be output temporarily.

In the embodiments of the present invention, the descriptions of the embodiments in the present invention are emphasized respectively, regarding the part in some embodiments which is not described in detail, reference can be made to related descriptions in other embodiments.

One of ordinary skill in the art will notice that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, but such implementations should not be considered as going beyond the scope of the present application.

The aforesaid maintenance station management program can be stored in a computer readable storage medium. Based on this understanding, a whole or part of flow process of implementing the method in the aforesaid embodiments of the present application can also be accomplished by using computer program to instruct relevant hardware, the computer program can be stored in a computer readable storage medium. When the computer program is executed by the processor, the steps in the various method embodiments described above can be implemented. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc.

It needs to be explained that, the contents contained in the computer readable medium can be added or reduced appropriately according to the requirement of legislation and patent practice in a judicial district; for example, in some judicial districts, according to legislation and patent practice, the computer readable medium doesn't include electrical carrier signal and telecommunication signal.

As stated above, the aforesaid embodiments are only intended to explain but not to limit the technical solutions of the present application. Although the present application has been explained in detail with reference to the above-described embodiments, it should be understood for the one of ordinary skill in the art that, the technical solutions described in each of the above-described embodiments can still be amended, or some technical features in the technical solutions can be replaced equivalently; these amendments or equivalent replacements, which won't make the essential of corresponding technical solution to be broken away from the spirit and the scope of the technical solution in various embodiments of the present application, should all be included in the protection scope of the present application.

1. (canceled)

2. A maintenance station management method, wherein the management method is applied in a data management server and comprises:
receiving a transaction request of using a maintenance station from a first user;
calling a usage smart contract of the maintenance station to grant a permission of usage of the maintenance station to the first user according to the transaction request;
initiating a transaction payment request when the first user finishes using the maintenance station;
calling the usage smart contract to finish a payment transaction according to a transaction payment confirmation instruction of the first user, and performing a sharing according to a transaction sharing rule of the usage smart contract; and
sending transaction information to a block chain node device, so that the block chain node device registers the transaction information into a block chain.

3. The maintenance station management method according to claim 2, wherein, before receiving the transaction request of using the maintenance station from the first user, the method further comprises:
receiving a usage agreement of the maintenance station; and
sending the usage agreement to the block chain node device, so that the block chain node device generates the usage smart contract of the maintenance station according to the usage agreement.

4. The maintenance station management method according to claim 3, wherein, before receiving the usage agreement of the maintenance station submitted, the method further comprises:
receiving maintenance station information and investment cost information of the maintenance station submitted by a second user;
establishing a correlation between the investment cost information and the maintenance station information, generating digital asset information of the maintenance station; and
sending the digital asset information of the maintenance station to the block chain node device, so that the block chain node device registers the digital asset information of the maintenance station into a block chain.

5. The maintenance station management method according to claim 2, wherein, after sending the transaction information to the block chain node device, the method further comprises:
calculating return on investment according to the transaction information and the investment cost information of the maintenance station; and
sending the return on investment to the block chain node device, so that the block chain node device establish the correlation between the return on investment and the digital asset information of the maintenance station, and registers the correlation into the block chain.

6. The maintenance station management method according to claim 5, wherein, after sending the return on investment to the block chain node device, the method further comprises:
receiving a financing agreement submitted by the second user;
sending the financing agreement to the block chain node device, so that the block chain node device generates a financing smart contract of the maintenance station according to the financing agreement;
receiving financing amount information submitted by a third user; and
calculating return on investment of the third user according to the financing amount information.

7. A maintenance station management system comprising:
a data management server configured to: receive a transaction request of using a maintenance station from a first user and call a usage smart contract of the maintenance station to grant a permission of usage of the maintenance station to the first user according to the transaction request; initiate a transaction payment request and call the usage smart contract to finish a payment transaction according to a transaction payment confirmation instruction of the first user, and perform a sharing according to a transaction sharing rule of the usage smart contract, when the first user finishes using the maintenance station; and
a block chain node device configured to receive transaction information submitted by the data management server and register the transaction information into a block chain.

8. A data management server comprising a memory, a processor and maintenance station management program stored in the memory and executable by the processor, when executing the maintenance station management program, the processor is configured to:
receive a transaction request of using a maintenance station from a first user;
call a usage smart contract of the maintenance station to grant a permission of usage of the maintenance station to the first user according to the transaction request;
initiate a transaction payment request when the first user finishes using the maintenance station;
call the usage smart contract to finish a payment transaction according to a transaction payment confirmation instruction of the first user and perform a sharing according to a transaction sharing rule of the usage smart contract; and send transaction information to a block chain node device, so that the block chain node device registers the transaction information into a block chain.

9. The data management server according to claim 8, wherein the processor is further configured to:
receive a usage agreement of the maintenance station before receiving the transaction request of using the maintenance station from the first user; and send the usage agreement to the block chain node device, so that the block chain node device generates the usage smart contract of the maintenance station according to the usage agreement.

10. The data management server according to claim 9, wherein the processor is further configured to:
receive maintenance station information and investment cost information of the maintenance station submitted by a second user before receiving the usage agreement of the maintenance station submitted;
establish a correlation between the investment cost information and the maintenance station information and generate digital asset information of the maintenance station;
send the digital asset information of the maintenance station to the block chain node device, so that the block chain node device registers the digital asset information of the maintenance station into a block chain.

11. The data management server according to claim 8, wherein the processor is further configured to:
calculate return on investment according to the transaction information and the investment cost information of the maintenance station after sending the transaction information to the block chain node device; and send the return on investment to the block chain node device, such that the block chain node device establishes the correlation between the return on investment and the digital asset information of the maintenance station, and registers the correlation into the block chain.

12. The data management server according to claim 11, wherein the processor is further configured to: receive a financing agreement submitted by the second user after sending the return on investment to the block chain node device; send the financing agreement to the block chain node device, so that the block chain node device generates a financing smart contract of the maintenance station according to the financing agreement; receive financing amount information submitted by a third user; and calculate the return on investment of the third user according to the financing amount information.
